(19) United States
(12) Patent Application Publication
(10) Pub. No.: US 2024/0179215 A1
(43) Pub. Date: May 30, 2024

(54) ON-VEHICLE CONTROL DEVICE, ON-VEHICLE SYSTEM, INFORMATION PROCESSING METHOD AND PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-shi, Aichi-ken (JP)

(72) Inventors: Darmawan GO, Yokkaichi-shi, Mie (JP); Hirofumi URAYAMA, Yokkaichi-shi, Mie (JP); Tatsuya IZUMI, Osaka-shi, Osaka (JP); Hideyuki TANAKA, Osaka-shi, Osaka (JP); Yusuke YAMAMOTO, Osaka-shi, Osaka (JP); Kenta OGATA, Osaka-shi, Osaka (JP); Hideki GOTO, Toyota-shi, Aichi (JP); Yasuhiro YAMASAKI, Toyota-shi, Aichi (JP); Takashi YASUDA, Toyota-shi, Aichi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); TOYOTA JIDOSHA KABUSHIKI KAISHA, Toyota-shi, Aichi-ken (JP)

(21) Appl. No.: 18/574,629

(22) PCT Filed: Jun. 23, 2022
(86) PCT No.: PCT/JP2022/025016

§ 371 Date: Dec. 27, 2023

(30) Foreign Application Priority Data
Jul. 1, 2021 (JP) 2021-110298

(51) Int. Cl. H04L 67/12; B60R 16/023; H04L 41/0803

(52) U.S. Cl. CPC H04L 67/12; B60R 16/023; H04L 41/0803

(57) ABSTRACT

An in-vehicle control device is installed in a vehicle and comprises a control unit performing control related to communication between a first in-vehicle device and a second in-vehicle device via an in-vehicle network. The control unit generates setting information of the in-vehicle network according to a state of the vehicle, derives a required time period required to change a network setting according to the setting information in the first in-vehicle device, derives a required time period required to change a network setting according to the setting information in the second in-vehicle device, and performs a setting change instruction on at least one of the network setting in the first in-vehicle device and the network setting in the second in-vehicle device so that the derived two required time periods at least partially overlap with each other.

### CROSS-REFERENCE TO RELATED APPLICATIONS

This application is the U.S. national stage of PCT/JP2022/025016 filed on Jun. 23, 2022, which claims priority of Japanese Patent Application No. JP 2021-110298 filed on Jul. 1, 2021, the contents of which are incorporated herein.

### TECHNICAL FIELD

The present disclosure relates to an on-vehicle control device, an on-vehicle system, an information processing method and a program.

### BACKGROUND

A vehicle is mounted with on-vehicle devices including on-vehicle components for a power train system such as engine control and on-vehicle components for a body system such as air conditioning control, on-vehicle ECUs (Electronic Control Units) for controlling the on-vehicle components and a relay device for relaying communication between the on-vehicle components and the on-vehicle ECUs. The multiple on-vehicle devices are connected with one another to construct an in-vehicle network regarding the on-vehicle devices (on-vehicle components, on-vehicle ECUs and relay device) as nodes in the vehicle (Japanese Patent Application Laid-Open No. 2017-97851, for example). The multiple on-vehicle devices communicate with one another via the in-vehicle network.

Since Japanese Patent Application Laid-Open No. 2017-97851 does not take into account, when settings of the in-vehicle network are changed, quickly starting the communication via the changed in-vehicle network, it may require a long time until the communication via the changed in-vehicle network is started.

The present disclosure is made in view of such circumstances, and an object is to provide an on-vehicle control device and the like that, when settings of the in-vehicle network are changed, can quickly start communication via the changed in-vehicle network.

### SUMMARY

The on-vehicle control device according to one aspect of the present disclosure is an on-vehicle control device installed in a vehicle and comprising a control unit performing control related to communication between a first on-vehicle device and a second on-vehicle device via an in-vehicle network, and the control unit generates setting information of the in-vehicle network according to a state of the vehicle, derives a required time period required to change a network setting according to the setting information in the first on-vehicle device, derives a required time period required to change a network setting according to the setting information in the second on-vehicle device, and performs a setting change instruction on at least one of the network setting in the first on-vehicle device and the network setting in the second on-vehicle device so that the derived two required time periods at least partially overlap with each other.

### Effect of Disclosure

According to one aspect of the present disclosure, when settings of the in-vehicle network are changed, communication via the changed in-vehicle network can be started quickly.

### BRIEF DESCRIPTION OF DRAWINGS

FIG. 1 is a schematic diagram exemplifying the configuration of an on-vehicle system according to a first embodiment.

FIG. 2 is a block diagram exemplifying the configuration of an integrated ECU and an individual ECU.

FIG. 3 is an explanatory view illustrating an example of setting information.

FIG. 4 is a conceptual diagram exemplifying the contents of a setting information selection table.

FIG. 5 is a schematic diagram exemplifying the contents of a change time period table.

FIG. 6 is an explanatory view exemplifying changes of the settings in the integrated ECU and the individual ECUs performed by an arithmetic processing device of the integrated ECU.

FIG. 7 is an explanatory view exemplifying changes of the settings, not taking the required time period into account.

FIG. 8 is a sequence diagram illustrating one aspect of changes in the settings of an in-vehicle network.

FIG. 9 is a flowchart exemplifying the processing related to changes in the settings of the in-vehicle network to be performed by the arithmetic processing device of the integrated ECU.

FIG. 10 is a flowchart exemplifying the processing related to changes in the settings of the in-vehicle network performed by an arithmetic processing device of the individual ECU.

FIG. 11 is an illustrative view exemplifying changes of the setting in the integrated ECU and the individual ECU to be performed by the arithmetic processing device of the integrated ECU according to a second embodiment.

### DETAILED DESCRIPTION OF PREFERRED EMBODIMENTS

Embodiments of the present disclosure are first listed and described. At least parts of the embodiments described below may arbitrarily be combined.

An on-vehicle control device according to one aspect of the present disclosure is an on-vehicle control device installed in a vehicle and comprising a control unit performing control related to communication between a first on-vehicle device and a second on-vehicle device via an in-vehicle network, and the control unit generates setting information of the in-vehicle network according to a state of the vehicle, derives a required time period required to change a network setting according to the setting information in the first on-vehicle device, derives a required time period required to change a network setting according to the setting information in the second on-vehicle device, and performs a setting change instruction on at least one of the network setting in the first on-vehicle device and the network setting in the second on-vehicle device so that the derived two required time periods at least partially overlap with each other.

In such an aspect, the on-vehicle control device is so connected as to be able to communicate with another on-vehicle device, not the on-vehicle control device of itself. That is, in the in-vehicle network, two on-vehicle devices including at least the first on-vehicle device and the second on-vehicle device are connected to each other, and the first on-vehicle device or the second on-vehicle device may function as the on-vehicle control device. The control unit of the on-vehicle control device derives the respective required time periods for the first on-vehicle device and the second on-vehicle device. Though the following disclosure describes an example where the required time period for the first on-vehicle device is a first required time period and the required time period for the second on-vehicle device is a second required time period, the required time period may be either one of the first required time period and the second required time period. The required time period in the first required time period and the second required time period means a time period required to change the setting of the in vehicle network to another setting of the in-vehicle network. For example, the first on-vehicle device is described as an integrated ECU or an on-vehicle ECU including an end ECU or the like not having a relay function, while the second on-vehicle device is described as a relay device such as an individual ECU or the like having a relay function. Note that the on-vehicle devices that are so connected as to be able to communicate with each other via the in-vehicle network may include an external device (external equipment) that can be connected as required so as to be attached to or detached from the in-vehicle network in compliance with the plug and play provided in the vehicle, for example, not limited to the integrated ECU, the on-vehicle ECU such as an end ECU, a relay device and the like. The on-vehicle control device having a control unit performing control related to communication between the first on-vehicle device and the second on-vehicle control device that are so connected as to be able to communicate with each other via the in-vehicle network corresponds to, for example, the integrated ECU or the on-vehicle ECU such as an end ECU and the like, the relay device such as the individual ECU or the like having a relay function, or an external device (external equipment) that is connected so as to be attached to or detached from the in-vehicle network as necessary, for example. The control unit of the on-vehicle control device changes the settings in the on-vehicle ECU and the relay device in the order and at the time points according to the derived first required time period and second required time period such that the first period during which the network setting in the on-vehicle ECU is changed and the second periods during which the network settings in the multiple relay devices are changed overlap with each other. Specifically, such setting changes include generating, by the control unit, the setting information of the in-vehicle network in response to the occurrence of the event that requires to change the settings of the in-vehicle network. For example, when the above-described event occurs, the control unit generates the setting information by selecting setting information according to the event that occurs from multiple setting information stored in the accessible storage area in advance. The event that requires to change the settings of the in-vehicle network includes a change of the state of the vehicle, for example, a transition from the state where the vehicle performs the automatic driving to the state where the vehicle performs the manual driving, and vice versa. The above-described event also includes connection of an additional device to the relay device, acceptance of an operation related to the change in the settings of the in-vehicle network performed by the occupant of the vehicle, obtaining a program update applied to the vehicle C and the occurrence of an abnormality in the relay device or the device connected to the relay device. Furthermore, the setting changes include changing the network setting in the on-vehicle ECU using the setting information generated by the control unit. Moreover, the setting changes include outputting to the relay devices, by the control unit, a change instruction (setting change instruction) generated using the setting information in order to cause the relay devices to change the network setting. The setting information is generated before the change of the network setting in the on-vehicle ECU and the output of the change instruction to the relay devices. The control unit changes the network setting in the on-vehicle ECU and outputs the change instruction to the relay devices in the order and at the time points according to the first required time period and the second required time period such that the first period and the second periods overlap with one another in changing the network settings in the on-vehicle ECU and the relay devices. By overlapping the first period and the second periods, the variation between the time when the change of the network setting in the on-vehicle ECU is completed and the time when the changes of the network settings in the relay devices are completed can be reduced. After completion of the change of the network setting in the on-vehicle ECU and the changes of the network settings in the relay devices, communication via the changed in-vehicle network is performed. Since the first period and the second periods overlap in changing the settings of the in-vehicle network, the on-vehicle ECU can reduce the time required to change the settings of the in-vehicle network as compared to when the first period and the second periods do not overlap with one another. Accordingly, in changing the settings of the in-vehicle network, the on-vehicle ECU can quickly start communication via the changed in-vehicle network.

The on-vehicle control device according to one aspect of the present disclosure is included in at least one of the first on-vehicle device and the second on-vehicle device.

In such an aspect, the on-vehicle control device is included in at least one of the first on-vehicle device and the second on-vehicle device, and the first on-vehicle device or the second on-vehicle device functions as the on-vehicle control device. That is, the on-vehicle control device corresponds to the first on-vehicle device or the second on-vehicle device. The first on-vehicle device or the second on-vehicle device corresponds to the on-vehicle control device, so that in changing the settings of the in-vehicle network connected with two on-vehicle devices, the on-vehicle control device can quickly start communication via the changed in-vehicle network.

In the on-vehicle control device according to one aspect of the present disclosure, the control unit includes a relay processing unit that performs relay processing of communication between the first on-vehicle device and the second on-vehicle device, the control unit specifies an order of and a time point at which changes of the network settings are started by the first on-vehicle device and the second on-vehicle device based on the required time periods, outputs the setting information to the relay processing unit and performs a setting change instruction on at least one of the network setting in the first on-vehicle device and the network setting in the second on-vehicle device, according to specified order and time point, and the relay processing unit starts changing the network setting according to the outputted setting information.

In such an aspect, the control unit includes the derivation unit and the relay processing unit. The derivation unit derives the required time periods (first required time period and second required time period). The derivation unit outputs the setting information to the relay processing unit and outputs a setting change instruction to the relay device in the order and at the time points according to the derived first required time period and second required time period. The relay processing unit performs relay processing based on the output setting information. The on-vehicle ECU can relay communication efficiently.

In the on-vehicle control device according to one aspect of the present disclosure, the relay processing unit functions as a layer 2 switch or a layer 3 switch.

In such an aspect, the relay processing unit functions as a layer 2 switch or a layer 3 switch, which allows the relay processing unit to efficiently perform the relay processing of communication depending on each layer.

In the on-vehicle control device according to one aspect of the present disclosure, the control unit specifies a longest required time period for each of the required time periods, and performs a setting change instruction on at least one of the network setting in the first on-vehicle device and the network setting in the second on-vehicle device so that in a time period during which one of the network settings that requires the specified longest required time period is being changed, the other one of the network settings is changed.

In such an aspect, the control unit changes the settings so that in a time period during which the network setting with the longest required time period is being changed, the change of the network setting with the other required time period is started and completed, out of the derived required time periods (required time periods including the first required time period and the second required time period). When the change of the network setting with the longest required time period is completed, the network setting with the other required time period has already been completed, and thus the change of the settings of the in-vehicle network is completed. The on-vehicle ECU can efficiently change the network settings of the on-vehicle ECU and the relay device. The on-vehicle ECU can more reduce the time required to change the settings of the in-vehicle network. Accordingly, in changing the settings of the in-vehicle network, the on-vehicle ECU can quickly start communication via the changed in-vehicle network.

The on-vehicle control device according to one aspect of the present disclosure performs a setting change instruction on at least one of the network setting in the first on-vehicle device and the network setting in the second on-vehicle device so that a time point when a change of the network setting in the first on-vehicle device is completed coincides with a time point when a change of the network setting in the second on-vehicle device is completed.

In such an aspect, the control unit changes the settings so that a first time point when a change of the network setting in the on-vehicle ECU is completed coincides with second time points when changes of the network settings in the multiple relay devices are completed. Note that the first time point and the second time points do not necessarily strictly coincide with each other. For example, the first time point and the second time points may substantially coincide, including errors within the range allowed by the specification. The time points when the network setting in the on-vehicle ECU and the network setting the relay devices are completed coincide with each other, and thus when the change of the network setting with the longest required time period out of the required time period including the derived first required time period and second required time period is completed, the change of the settings of the in-vehicle network is completed. The on-vehicle ECU can efficiently change the network settings in the on-vehicle ECU and the relay devices. The on-vehicle ECU can more reduce the time required to change the settings of the in-vehicle network. Accordingly, in changing the setting of the in-vehicle network, the on-vehicle ECU can quickly start communication via the changed in-vehicle network. In the case where two relay devices are connected to the on-vehicle ECU and the network setting is changed in one of the relay devices, for example, the on-vehicle ECU and the other one of the relay devices can communicate with each other until a change of the network setting in the on-vehicle ECU or the other one of the relay devices is started. Since the setting changes are performed so that the first time point, the second time point for one relay device and the second time point for the other relay device coincide with each other, in the period during which the network setting in the one relay device is being changed, the period during which the on-vehicle ECU and the other relay device before start of the change of the network setting can communicate can be extended.

In the on-vehicle control device according to one aspect of the present disclosure, the required time period for the second on-vehicle device includes a reception time period from a time point when the control unit outputs the setting change instruction to the second on-vehicle device to a time point when the second on-vehicle device completes reception processing in response to the setting change instruction, and a change time period from a time point when a change of the network setting is started to a time point when the change of the network setting is completed based on the setting change instruction for which the reception processing is completed in the second on-vehicle device.

In such an aspect, the required time period (second period) of the second on-vehicle device includes the reception time period and the change time period. The reception time period is a time period from a time point when the control unit outputs a setting change instruction to the relay device to a time point when the relay device completes reception processing in response to the setting change instruction. The relay device receives (acquires) the change instruction output from the on-vehicle ECU and converts the received change instruction to a state available for the change of the network setting in the relay device in the reception processing. In the case where the change instruction includes setting information, the relay device retrieves the setting information included in the change instruction from the received change instruction. During the reception time period, the on-vehicle ECU and the relay device communicate with each other for changing the network setting in the relay device. The change time period is a time period from a time point when a change of the network setting is started based on the setting information retrieved from the change instruction in the relay device to a time point when the change of the network setting is completed based on the setting information. Taking into account the communication for changing the network setting in the relay device and the time required for the reception processing as the reception time period, the control unit can accurately derive the time required to change the network setting in the relay device. The control unit derives the time period from the time point when a change instruction is output to the relay device to the time point when the change of the network setting in the relay device is completed as the second required time, which enables changes of the settings in an order and at the time points more appropriately.

In the on-vehicle control device according to one aspect of the present disclosure, the control unit generates, in the case where an event that shifts a state of the vehicle is detected, the setting information based on the event.

In such an aspect, the control unit generates the setting information of the in-vehicle network based on the event according to the state of the vehicle. The state of the vehicle includes, for example, the automatic driving state where the vehicle performs automatic driving and the manual driving state where the vehicle performs manual driving. The event according to the state of the vehicle includes a transition of the state in the vehicle, for example, from any one of the automatic driving stat to the manual driving state, and the vice versa, that is, the event occurs when the state of the vehicle shifts. Such an event may occur regarding, as a trigger, changing the driving mode operated by the operator of the vehicle, receiving data transmitted from the external server or the like, receiving data transmitted from traffic facilities such as signals through inter-vehicle communication, or receiving data transmitted from another vehicle by vehicle-to-vehicle communication. The control unit changes the network setting in the on-vehicle ECU using the generated setting information based on the type or classification of the detected event. In addition, the control unit outputs the change instruction generated by using the generated setting information to the relay device. The control unit can change the settings of the in-vehicle network according to the state of the vehicle.

In the on-vehicle control device according to one aspect of the present disclosure, the in-vehicle network is connected to a plurality of the second on-vehicle devices functioning as relay devices, and the control unit of the first on-vehicle device functioning as the on-vehicle control device controls communication with the relay devices.

In such an aspect, since the control unit of the on-vehicle control device controls the communication with the relay device, and another on-vehicle device (second on-vehicle device) corresponds to multiple relay devices. Thus, in changing the settings of the in-vehicle network to which the multiple relay devices are connected, the control unit can quickly start communication via the changed in-vehicle network.

An on-vehicle system according to one aspect of the present disclosure is an on-vehicle system installed in a vehicle and comprising a first on-vehicle device and a second on-vehicle device so connected as to be able to communicate with each other via an in-vehicle network, at least one of the first on-vehicle device and the second on-vehicle device functioning as an on-vehicle control device having a control unit, the control unit generates setting information of the in-vehicle network according to a state of the vehicle, derives a required time period required to change a network setting according to the setting information in the first on-vehicle device, derives a required time period required to change a network setting according to the setting information in the second on-vehicle device, and performs a setting change instruction on at least one of the network setting in the first on-vehicle device and the network setting in the second on-vehicle device so that the derived required time periods at least partially overlap with each other.

In such an aspect, the on-vehicle system includes the multiple on-vehicle devices (first on-vehicle device and the second on-vehicle device). In changing the settings of the in-vehicle network, one (on-vehicle control device) of the on-vehicle devices (first on-vehicle device and second on-vehicle device) derives the above-mentioned first required time period and second required time period. The on-vehicle device (on-vehicle control device) performs setting changes on the on-vehicle device of itself and the other on-vehicle device so that the above-mentioned first period overlaps with the above-mentioned second period in the order and at the time points according to the derived first required time period and second period. Specifically, in changing the settings, the on-vehicle device generates the changed setting information of the in-vehicle network, changes the network settings in the on-vehicle device using the changed setting information of the in-vehicle network, and outputs the change instruction generated using the changed setting information of the in-vehicle network to the other on-vehicle device. The other on-vehicle device acquires the change instruction output from the on-vehicle device. The other on-vehicle device changes the network setting in the device of itself based on the acquired change instruction. For example, the other on-vehicle device uses the setting information included in the acquired change instruction to change the network setting in the device of itself. Since in changing the settings of the in-vehicle network, the first period and the second period overlap with each other, the time required to change the setting of the in-vehicle network in the on-vehicle system can be more reduced as compared with when the first period and the second period do not overlap with each other. Therefore, in changing the settings of the in-vehicle network in the on-vehicle system, it is possible to quickly start communication via the changed in-vehicle network.

An information processing method according to one aspect of the present disclosure causes an on-vehicle control device installed in a vehicle and performing control related to communication between a first on-vehicle device and a second on-vehicle device via an in-vehicle network to execute processing of generating setting information of the in-vehicle network according to a state of the vehicle; deriving a required time period required to change a network setting according to the setting information in the first on-vehicle device; deriving a required time period required to change a network setting according to the setting information in the second on-vehicle device; and performing a setting change instruction on at least one of the network setting in the first on-vehicle device and the network setting in the second on-vehicle device so that the derived required time periods at least partially overlap with each other.

In such an aspect, it is possible to provide the information processing method that allows the on-vehicle device to function as the on-vehicle device according to one aspect of the present disclosure.

A program according to one aspect of the present disclosure causes an on-vehicle control device installed in a vehicle and performing control related to communication between a first on-vehicle device and a second on-vehicle device via an in-vehicle network to execute processing of: generating setting information of the in-vehicle network according to a state of the vehicle; deriving a required time period required to change a network setting according to the setting information in the first on-vehicle device; deriving a required time period required to change a network setting according to the setting information in the second on-vehicle device; and performing a setting change instruction on at least one of the network setting in the first on-vehicle device and the network setting in the second on-vehicle device so that the derived required time periods at least partially overlap with each other.

In such an aspect, it is possible to provide the program that allows the on-vehicle device to function as the on-vehicle device in one aspect of the present disclosure.

The present disclosure will be described below with reference to the drawings illustrating the present embodiments. On-vehicle ECUs according to the embodiments of the present disclosure will be described below with reference to the drawings. The present disclosure is not limited to the exemplification, and all changes that fall within the meaning equivalent to the claims and the scope are to be embraced.

### First Embodiment

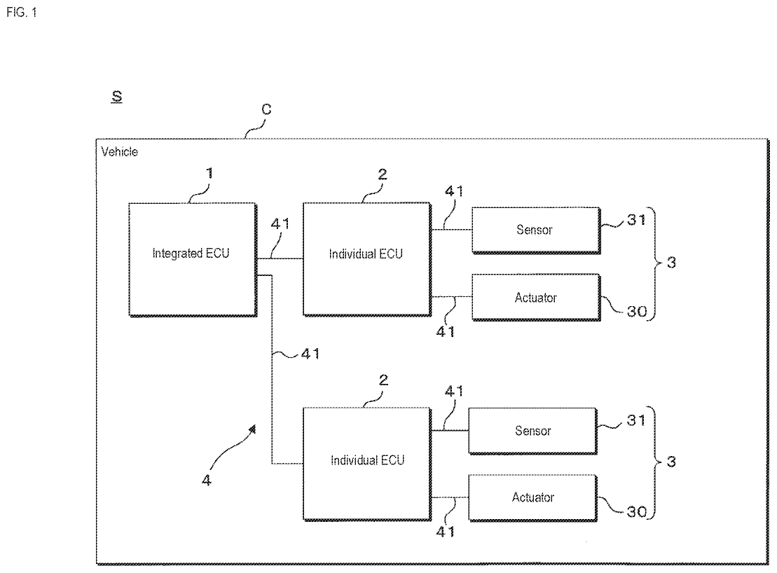

The present embodiment will be described below based on the drawings thereof. FIG. 1 is a schematic diagram exemplifying the configuration of an on-vehicle system S according to a first embodiment. The on-vehicle system S includes multiple ECUs mounted on a vehicle C. The multiple ECUs include an integrated ECU 1 and several individual ECUs 2. The vehicle C has two individual ECUs 2 in FIG. 1, but the number of individual ECUs 2 installed in the vehicle C may be equal to or more than three, not limited to two. Hereafter, the integrated ECU 1 and the individual ECUs 2 are collectively referred to as ECUs.

The integrated ECU 1 and each individual ECU 2 are connected through a communication line 41 complying with a communication protocol such as Ethernet, for example. The communication line 41 is an Ethernet cable, for example. Each individual ECU 2 is connected with multiple on-vehicle components 3 through the communication lines 41.

In the on-vehicle system S illustrated in FIG. 1, the integrated ECU 1 and the individual ECUs 2 are connected to construct an in-vehicle network 4 forming of a star network topology. The integrated ECU 1 is located at the center of the star network topology. The network topology may be a cascade network topology. At the top of the cascade network topology, for example, the integrated ECU 1 is provided. The network topology in the on-vehicle system S is not limited to the above examples. The on-vehicle system S may be configured as a loop network topology in which adjacent individual ECUs 2 are connected, which enables bidirectional communication to achieve redundancy. The network topology may be a daisy chained network topology.

The individual ECUs 2 are respectively located in areas of the vehicle C and are each connected to the multiple on-vehicle components 3. Each individual ECU 2 transmits and receives signals or data to/from the on-vehicle components 3 connected thereto. Each individual ECU 2 also communicates with the integrated ECU 1. Each individual ECU 2 also functions as a relay device such as a gateway, an Ethernet switch or the like that relays the communication, and relays communication between the multiple on-vehicle components 3 connected thereto or communication between the on-vehicle components 3 and other ECUs including the integrated ECU 1. Each individual ECU 2 may function as a power distribution device that distributes and relays the power output from a power storage device (not illustrated) and supplies it to the on-vehicle components connected to the ECU 2 of itself, in addition to relay of communications. Such an individual ECU 2 corresponds to a relay device.

The on-vehicle components 3 include an actuator 30 such as a door opening or closing device, a motor device and the like and various sensors 31 such as Light Detection and Ranging (LiDAR), a light sensor, a COMS camera and an infrared sensor and the like. The on-vehicle components 3 are not limited to the above-described example and may include a switch such as a door SW (switch), a lamp SW or the like, or a lamp. The on-vehicle components 3 may include existing on-vehicle components 3 installed in the vehicle C in advance and additional on-vehicle components 3 installed in the vehicle C later than the time when the existing on-vehicle components 3 are installed in the vehicle C. For example, the additional on-vehicle components 3 are plug-and-play compatible. The time when the existing on-vehicle components 3 are installed in the vehicle C is at the time when the vehicle C is manufactured, for example.

The integrated ECU 1 is a central control device such as a vehicle computer, for example. Based on data from the on-vehicle components 3 relayed via the individual ECUs 2, the integrated ECU 1 generates control signals and output them to the respective on-vehicle components 3. The integrated ECU 1 generates a control signal for controlling the actuator 30 as a target of the request signal based on information or data such as a request signal or the like output from one of the individual ECUs 2 and outputs the generated control signal to the other one of the individual ECUs 2.

The integrated ECU 1 also functions as a relay device for relaying communications, such as a gateway, an Ethernet switch or the like. The integrated ECU 1 relays communication between the individual ECUs 2 connected thereto (the ECU of itself). The integrated ECU 1 further relays communications between the multiple on-vehicle components 3 connected to the different individual ECUs 2 via the individual ECUs 2. For example, the integrated ECU 1 in FIG. 1 is connected to the two individual ECUs 2. The integrated ECU 1 relays communication between the on-vehicle components 3 connected to one of the individual ECUs 2 and the on-vehicle components 3 connected to the other one of the individual ECUs 2 via the two individual ECUs 2.

The integrated ECU 1 may be connected to be able to communicate with an external server (not illustrated) connected to an external network such as the Internet or the like via an outside-vehicle communication device (not illustrated). For example, the integrated ECU 1 and the outside-vehicle communication device are separately provided and connected to be able to communicate with each other. The outside-vehicle communication device may be incorporated in the integrated ECU 1. The external server may be an OTA (over the Air) server that transmits (distributes) control programs of the integrated ECU 1, the individual ECUs 2 and the on-vehicle components 3 installed in the vehicle C and updates the various control programs applied to the vehicle C.

As detailed below, if the settings of the in-vehicle network 4 need to be changed, the integrated ECU 1 changes the network setting in the integrated ECU 1 (the ECU of itself). In addition, the integrated ECU 1 causes the individual ECUs 2 connected thereto to change the network settings in the individual ECUs 2. After completion of changing the settings in the integrated ECU 1 and the individual ECUs 2, communication via the in-vehicle network 4 where settings are changed (hereinafter referred to as a changed in-vehicle network) is performed in the on-vehicle system S. The communication via the in-vehicle network 4 employs the Ethernet (registered trademark) communication protocol, for example. The integrated ECU 1 corresponds to an on-vehicle ECU.

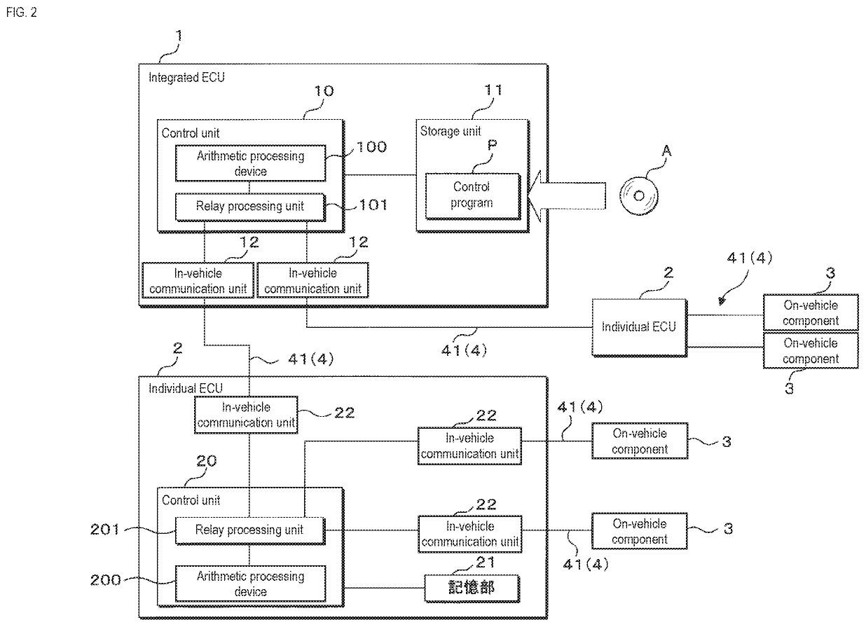

FIG. 2 is a block diagram exemplifying the configuration of the integrated ECU 1 and the individual ECU 2. The integrated ECU 1 is installed with a control unit 10, a storage unit 11 and an in-vehicle communication unit 12. The control unit 10 is connected to the storage unit 11 and the in-vehicle communication unit 12. The control unit 10 includes an arithmetic processing device 100 such as a CPU (Central Processing Unit), an MPU (Micro Processing Unit) or the like and a relay processing unit 101 that performs relay processing in the integrated ECU 1.

The arithmetic processing device 100 (control unit 10) is configured to perform various control processing and arithmetic processing by reading and executing the control program P and data that are stored in the storage unit 11 in advance. The arithmetic processing device 100 includes a single CPU with a single core, a multi-CPU with a single core, a single CPU with multiple cores and a multi-CPU with multiple cores. The arithmetic processing device 100 is not limited to a software processing unit that performs software processing such as a CPU or the like, but may include a hardware processing unit that performs various control processing and arithmetic processing in hardware processing such as an FPGA (field Programmable Gate Array), ASIC (Application specific Integrated Circuit), SoC (System on a Chip) or the like.

The relay processing unit 101 is composed of, for example, an Ethernet switch IC (Integrated Circuit) or an Ethernet switch IC with an arithmetic processing function. The relay processing unit 101 may be composed of a combination of a CPU or an MPU and an Ethernet switch IC. The relay processing unit 101 is an Ethernet switch functioning as a Layer 2 switch or a Layer 3 switch. The arithmetic processing device 100 and the relay processing unit 101 are connected to each other. The relay processing unit 101 is connected to the in-vehicle communication unit 12.

The storage unit 11 is composed of volatile memory elements such as RAM (Random Access Memory) or non-volatile memory elements such as ROM (Read only Memory), EEPROM (electrically Erasable Programmable ROM) or flash memory. The storage unit 11 may be composed of a combination of memory devices such as the volatile memory element and the non-volatile memory element described above. The storage unit 11 stores in advance a control program P (program product) and data to be referred during processing. The storage unit 11 also stores information on a network setting for relay processing.

The control program P (program product) stored in the storage unit 11 may be obtained by storing the control program P (program product) read from a recording medium A that is readable by the integrated ECU 1. The control program P (program product) stored in the storage unit 11 may be obtained by the integrated ECU 1 downloading the control program P (program product) from an external computer (not illustrated) connected to a communication network (not illustrated) and storing it in the storage unit 11.

The in-vehicle communication unit 12 is an input/output interface using a communication protocol such as Ethernet, for example. The in-vehicle communication unit 12 includes an Ethernet PHY part, for example. The in-vehicle communication unit 12 is connected to an in-vehicle communication unit 22 provided in the individual ECU 2 through a communication line 41. The arithmetic processing device 100 communicates with the individual ECUs 2 or the on-vehicle components 3 connected to the in-vehicle network 4 through the relay processing unit 101 and the in-vehicle communication unit 12. Multiple in-vehicle communication units 12 are provided. The in-vehicle communication units 12 are respectively connected with the communication lines 41, which constitute the in-vehicle network 4.

The individual ECU 2 is installed with a control unit 20 including an arithmetic processing device 200 and a relay processing unit 201, a storage unit 21 and the in-vehicle communication unit 22. The arithmetic processing device 200, the relay processing unit 201, the control unit 20, the storage unit 21 and the in-vehicle communication unit 22 of the individual ECU 2 have the same configurations as the arithmetic processing device 100, the relay processing unit 101, the control unit 10, the storage unit 11 and the in-vehicle communication unit 12 of the integrated ECU 1.

The individual ECU 2 is provided with multiple in-vehicle communication units 22. Some of the multiple in-vehicle communication units 22 of the multiple in-vehicle communication units 22 are connected to the in-vehicle communication units 12 of the integrated ECU 1 via the communication lines 41. The rest of the in-vehicle communication units 22 are connected to the on-vehicle components 3 through the communication line 41.

For example, at least one of the integrated ECU 1 and the individual ECU 2 may have an Input/Output interface (not illustrated), which is a communication interface for performing serial communication. For example, the input/output interface is connected, through a serial cable, with a display device (not illustrated), such as a display that is mounted on the vehicle C and an IG (ignition) switch (not illustrated) that starts and stops the vehicle C. The input/output interface is also connected, via a serial cable, with an input device (not illustrated) that accepts an operation by the occupant of the vehicle C, e.g., the driver. The input device is a touch panel, for example. The input device is integrated with the display device, for example. The input device accepts a change operation for changing the settings of the in-vehicle network 4, for example. The display device and the input device may be included in the on-vehicle component 3.

For example, the integrated ECU 1 and the individual ECU 2 have connection ports (not illustrated) for connecting with the integrated ECU 1, the individual ECU 2 or the on-vehicle component 3. For example, the connection port is included in the in-vehicle communication unit 12 of the integrated ECU 1 and the in-vehicle communication unit 22 of the individual ECU 2. The connection port may be included in the above-mentioned input/output interface in addition to the in-vehicle communication unit 12 of the integrated ECU 1 and the in-vehicle communication unit 22 of the individual ECU 2.

In the vehicle C, the in-vehicle network 4 including the integrated ECU 1, the individual ECUs 2 and the on-vehicle components 3 as nodes is constructed. Specifically, in the integrated ECU 1 and each individual ECU 2, network settings are made according to the setting information for setting the in-vehicle network 4. Such network settings in the integrated ECU 1 and in each individual ECU 2 allow the integrated ECU 1, the individual ECUs 2 and the on-vehicle components 3 to communicate with one another via the in-vehicle network 4. The details of the setting information are described below.

In the case where changes in the settings of the in vehicle network 4 are required, the integrated ECU 1 changes the settings of the in-vehicle network 4. The case where the setting of the in-vehicle network 4 is required to be changed includes the case where the state of the vehicle C is changed. The state of the vehicle C includes a manual driving state where manual driving is performed in the vehicle C and an automatic driving state where automatic driving is performed in the vehicle C. The case where the state of the vehicle C is changed means a transition from the state where the vehicle performs the automatic driving to the state where the vehicle performs the manual driving, and vice versa.

Furthermore, the case where changes in the settings of the in-vehicle network 4 are required includes the situation where an additional on-vehicle component 3 is mounted and connected to the individual ECU 2. Moreover, the case where the settings of the in-vehicle network 4 are required to be changed includes the situation where a change operation by the occupant of the vehicle C is accepted.

Additionally, the case where changes in the settings of the in-vehicle network 4 are required includes the situation where the integrated ECU 1 obtains a program update to the program applied to the vehicle C from the external server, e.g., the OTA server, that is, the situation where the program applied to the vehicle C is updated. In addition, the case where changes in the settings of the in-vehicle network 4 are required includes the situation where an abnormality occurs in the individual ECU 2 or the on-vehicle component 3, for example,

Change of the state of the vehicle C, connection of an additional on-vehicle component 3, acceptance of a change operation, obtaining program update and occurrence of an abnormality are included in the event that requires to change the settings of the in-vehicle network 4. When such an event occurs, the integrated ECU 1 detects the event and changes the setting of the in-vehicle network 4. Note that the event that requires to change the settings of the in-vehicle network 4 is not limited to the above-described examples. For example, the state of the vehicle C may include a stopped state where the IG switch of the vehicle C is stopped in addition to the manual driving state and the automatic driving state. A change (transition) in the state of the vehicle C corresponds to an event according to the state of the vehicle.

In the case where changes in the settings of the in vehicle network 4 are required, that is, in the case where the event that requires to change the settings of the in-vehicle network 4 occurs, the arithmetic processing device 100 (control unit 10) of the integrated ECU 1 generates (acquires) setting information of the changed in-vehicle network 4. In other words, the arithmetic processing device 100 of the integrated ECU 1 generates setting information according to the event that requires to change the settings of the in-vehicle network 4.

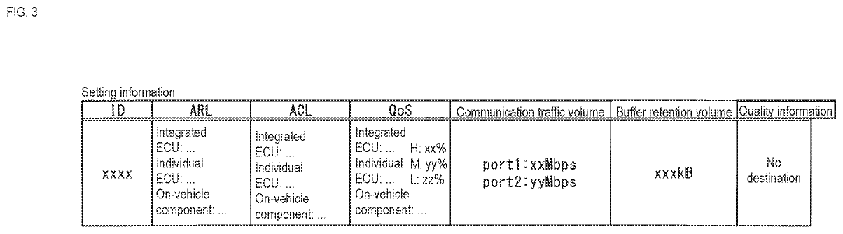

FIG. 3 is an explanatory view illustrating an example of the setting information. The setting information is stored in the storage unit 11 of the integrated ECU 1 in tabular form, for example. The storage area in which the setting information to be referred to by the arithmetic processing device 100 of the integrated ECU 1 is stored is not limited to the storage unit 11 of the integrated ECU 1, but may be, for example, a storage area accessible to the integrated ECU 1, such as a storage device of the individual ECU 2 or an external cloud server, for example.

The setting information is stored in the storage unit 11 of the integrated ECU 1 as initial information at the manufacturing state of the vehicle C, for example. Even after the vehicle C is shipped to the market thereafter, the setting information is updated (upgraded) with the setting information obtained (downloaded) from the external server through communications between the integrated ECU 1 and the external server.

The setting information is stored (saved) in tabular form, and the table contains an Identifier (ID) column, an Address Resolution Logic table (ARL) column, an Access Control List (ACL) column, a Quality of Service (QOS) column, a communication traffic volume (design value) column, a buffer retention volume (design value) column and a quality information (design value) column, for example.

The ID column stores an ID to identify setting information. For example, the ID may be a version number of the setting information. The ARL column stores a MAC address table showing the correspondence between the MAC address of at least one of the integrated ECU 1, the individual ECU 2 and the on-vehicle component 3 that are to be connected and a physical port number of the connection port that is being connected. In the case where the integrated ECU 1 or the individual ECU 2 relays Ethernet packets, it functions as a Layer 2 switch by referring to the ARL. The ARL column may also contain a routing table that shows the correspondence between MAC addresses and IP addresses. The integrated ECU 1 or the individual ECU 2 also functions as a Layer 3 switch by referring to the ARL column that contains the routing table.

The ACL column stores information related to access control settings used when performing service communication at least one of between the integrated ECU 1 and the individual ECU 2 and between the individual ECU 2 and the on-vehicle component 3, for example. The QoS column stores information related to priority order, bandwidth guarantee and the like for each packet as a target to be relayed in performing relay processing, for example.

The communication traffic volume column stores a design value (specification value defined in the design) of the communication traffic volume in at least one of each in-vehicle communication unit 12 of the integrated ECU 1 and each in-vehicle communication unit 22 of the individual ECU 2, for example. The communication traffic volume includes two types of communication traffic volumes when the integrated ECU 1 or the individual ECU 2 transmits data to another device and when the integrated ECU 1 or the individual ECU 2 receives data from another device.

The buffer retention volume column stores a design value (specification value defined in the design) of the buffer retention volume of at least one of each in-vehicle communication unit 12 of the integrated ECU 1 and each in-vehicle communication unit 22 of the individual ECU 2, for example.

The quality information column stores a design value (specification value defined in the design) related to communication quality such as whether packet discard is acceptable in at least one of each in-vehicle communication unit 12 of the integrated ECU 1 and each in-vehicle communication unit 22 of the individual ECU 2, for example. The setting information may include information related to a filter setting for the connection port of at least one of the integrated ECU 1 and the individual ECU 2. The information related to the filter setting includes information for setting a filter that does not pass communication data of a predetermined type, for example. The items such as ID, ARL, ACL, QOS, communication traffic volume, buffer retention volume and quality information included in the setting information are also referred to as parameters below.

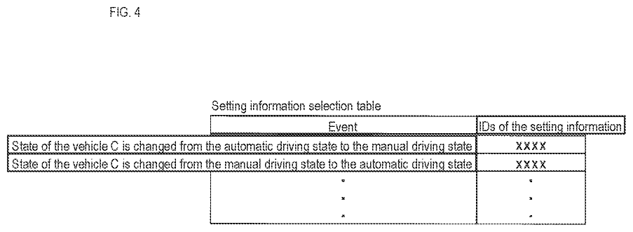

For example, in the storage area accessible to the arithmetic processing device 100 of the integrated ECU 1, multiple setting information and a setting information selection table for selecting setting information are stored in advance. FIG. 4 is a conceptual diagram exemplifying the contents of the setting information selection table. In the setting information selection table, events and the IDs of the setting information are stored in association with each other. Specifically, the setting information selection table contains an event column and an ID column of the setting information. The event column stores events that require to change the settings of the in-vehicle network 4. The setting information ID column stores the IDs of the setting information in association with the events. The storage area that is accessible to the arithmetic processing device 100 of the integrated ECU 1 is the storage unit 11 of the integrated ECU 1, for example.

In the case where changes in the settings of the in-vehicle network 4 are required, or in the case where the event that requires to change the settings of the in vehicle network 4 occurs, the arithmetic processing device 100 of the integrated ECU 1 generates (acquires) changed setting information of the in-vehicle network 4 as described below. The arithmetic processing device 100 of the integrated ECU 1 selects setting information according to an event that occurred out of the multiple setting information having been stored with reference to the setting information selection table to generate the changed setting information of the in-vehicle network 4. For example, by communicating with the external server to obtain the changed setting information of the in-vehicle network 4, the arithmetic processing device 100 of the integrated ECU 1 may also generate the changed setting information of the in-vehicle network 4.

If the state of the vehicle C is changed from the manual driving state to the automatic driving state, for example, the changed setting information of the in-vehicle network 4 is the setting information of the in-vehicle network 4 corresponding to the automatic driving state. Note that the setting information of the in-vehicle network 4 before change is the setting information of the in-vehicle network 4 corresponding to the manual driving state. Here, in the changed setting information of the in-vehicle network 4, at least one of the QoS, communication traffic volume, buffer retention volume and quality information, for example, is changed. The arithmetic processing device 100 of the integrated ECU 1 generates the setting information according to the state of the vehicle C, which enables appropriate changes in the settings of the in-vehicle network 4 according to the state of the vehicle C.

In the case where the arithmetic processing device 100 of the integrated ECU 1 acquires a program update, the changed setting information of the in-vehicle network 4 to be generated (selected) is the setting information of the in-vehicle network 4 corresponding to the vehicle C to which the program update is applied. Here, in the changed setting information of the in-vehicle network 4, at least one of the QoS, communication traffic volume, buffer retention volume and quality information, for example, is changed.

If an abnormality occurs in any one of the individual ECUs 2 and the on-vehicle components 3, the changed setting information of the in-vehicle network 4 is the setting information of the in-vehicle network 4 excluding the individual ECU 2 or the on-vehicle component 3 in which the abnormality occurred out of the integrated ECU 1, the individual ECUs 2 and the on-vehicle components 3. In the case where the individual ECUs 2 are connected to achieve redundancy, and an abnormality occurs in one of the individual ECUs 2, the changed setting information of the in-vehicle network 4 is the setting information of the in-vehicle network 4 that communicates (relays communication) without going through the individual ECU 2 in which the abnormality occurred. In these cases, at least one of the information on the filter settings, ARL and ACL, for example, is changed in the changed setting information of the in-vehicle network 4. For example, by employing the above-mentioned setting information, the communication path is changed. The communication path is changed to an alternative communication path that does not go through the individual ECU 2 in which the abnormality occurred, for example.

In the case where an additional on-vehicle component 3 is connected to the individual ECU 2, the changed setting information of the in-vehicle network 4 is the setting information of the in-vehicle network 4 to which the additional on-vehicle device 3 is added as a node. Here, at least one of ARL and ACL, for example, is changed in the changed setting information of the in-vehicle network 4. By employing the above-mentioned setting information, the communication path is added (changed). A new service by the additional on-vehicle component 3 is applied to the vehicle C.

In the case where changes in the settings of the in-vehicle network 4 are required, the arithmetic processing device 100 of the integrated ECU 1 changes the network settings in the integrated ECU 1 and the individual ECUs 2 in the order and at the time points corresponding to a first required time period and second required time periods. The first required time period is a time period required to change the network setting in the integrated ECU 1. The second required time periods are time periods required to change the network settings in the multiple individual ECUs 2. Although detailed later, the arithmetic processing device 100 of the integrated ECU 1 derives the first required time period and the second required time periods. The arithmetic processing device 100 corresponds to a derivation unit. Details of the order and at the time points according to the first required time period and second required time periods are described below.

In changing the settings, the arithmetic processing device 100 of the integrated ECU 1 generates setting information. The arithmetic processing device 100 of the integrated ECU 1 also changes the network setting in the integrated ECU 1 (device of itself) by using the generated setting information. In addition, the arithmetic processing device 100 of the integrated ECU 1 generates a change instruction, which is data or information to cause the individual ECUs 2 to change the network settings, using the generated setting information, and outputs the generated change instruction to the individual ECUs 2. For example, the arithmetic processing device 100 of the integrated ECU 1 generates a change instruction including the setting information and outputs the generated change instruction to the individual ECUs 2. The arithmetic processing device 100 of the integrated ECU 1 may output the setting information to the individual ECUs 2 as a change instruction. The setting change includes generating setting information, changing of the network setting in the integrated ECU 1 using the setting information and outputting a change instruction to the individual ECUs 2.

In changing the settings, the arithmetic processing device 100 of the integrated ECU 1 first generates setting information. When changing the network setting in the integrated ECU 1 based on the generated setting information, the arithmetic processing device 100 of the integrated ECU 1 outputs the setting information to the relay processing unit 101 of the integrated ECU 1. Specifically, the arithmetic processing device 100 of the integrated ECU 1 outputs the parameters for the changed setting information of the in-vehicle network 4 to the relay processing unit 101 of the integrated ECU 1 to cause the relay processing unit 101 of the integrated ECU 1 to change the parameters. In other words, the arithmetic processing device 100 of the integrated ECU 1 applies the setting information to the relay processing unit 101 of the integrated ECU 1.

For example, the setting information related to the integrated ECU 1 and the setting information related to each of the individual ECUs 2 are combined as single setting information. The setting information related to the integrated ECU 1 is parameters for the network setting in the integrated ECU 1. The setting information related to each individual ECU 2 is parameters for the network setting in each individual ECU 2.

For example, the arithmetic processing device 100 of the integrated ECU 1 specifies setting information related to the integrated ECU 1 from the generated setting information, and outputs the specified setting information related to the integrated ECU 1 to the relay processing unit 101 of the integrated ECU 1. Moreover, the arithmetic processing device 100 of the integrated ECU 1 specifies setting information related to the individual ECU 2 from the generated setting information, and outputs a change instruction including the specified setting information related to the individual ECU 2 to the individual ECU 2. Note that the arithmetic processing device 100 of the integrated ECU 1 may output to the individual ECU 2 a change instruction including the setting information consisting of the setting information related to the integrated ECU 1 and the setting information related to each of the individual ECUs 2 as a single piece. The individual ECU 2 specifies the setting information related to the individual ECU 2 from the setting information included in the output change instruction.

The setting information may be configured such that the setting information related to the integrated ECU 1 and the setting information related to each of the individual ECUs 2 are separately provided so as to be associated with one another. Here, the arithmetic processing device 100 of the integrated ECU 1 generates the setting information related to the integrated ECU 1 and the setting information related to each individual ECU 2 that are associated with one another and outputs the setting information related to the integrated ECU 1 to the relay processing unit 101 of the integrated ECU 1. The arithmetic processing device 100 of the integrated ECU 1 further outputs a change instruction including the setting information related to each individual ECU 2 to each of the individual ECUs 2.

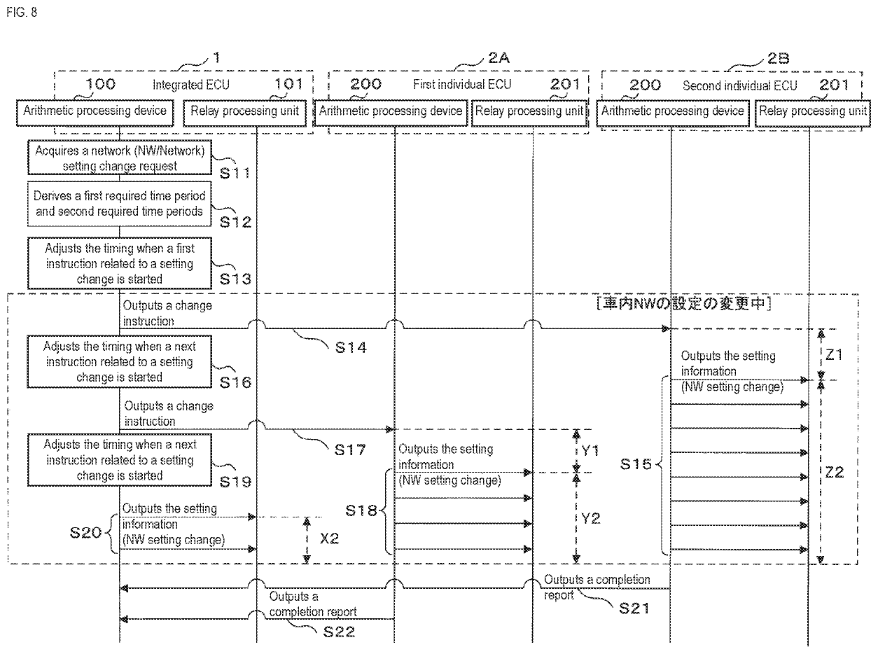

The time point when the arithmetic processing device 100 of the integrated ECU 1 starts outputting the setting information to the relay processing unit 101 of the integrated ECU 1 corresponds to the time point when change of the network setting in the integrated ECU 1 is started. The time point when the relay processing unit 101 of the integrated ECU 1 completes the changes of all the parameters that need to be changed in the integrated ECU 1 out of the parameters for the network settings corresponds to the time point when the change of the network setting in the integrated ECU 1 is completed. Accordingly, the first required time period is a time period from the time point when the relay processing unit 101 of the integrated ECU 1 starts outputting the setting information to the time point when the relay processing unit 101 of the integrated ECU 1 completes the change of the parameters for the network setting. In FIG. 8 described below, the first required time period is denoted by X2.

The larger the number of parameters to be changed is, the longer the time to change the parameters is, thereby increasing the first required time period. The smaller the number of parameters to be changed is, the shorter the time to change the parameters is, thereby reducing the first required time period. For example, in outputting the setting information to the relay processing unit 101 of the integrated ECU 1, the arithmetic processing device 100 of the integrated ECU 1 communicates with the relay processing unit 101 many times. The larger the number of parameters to be changed, the larger the number of communications described above is. The smaller the number of parameters to be changed is, the smaller the number of communications described above is.

As described above, in changing the settings, the arithmetic processing device 100 of the integrated ECU 1 outputs a change instruction to each of the individual ECUs 2. In the present embodiment, the vehicle C is mounted with the two individual ECUs 2. Hereafter, one of the individual ECUs 2 is also referred to as a first individual ECU 2A. The other one of the individual ECUs 2 is also referred to as a second individual ECU 2B. The change instruction to be output to the first individual ECU 2A includes setting information related to the first individual ECU 2A. The change instruction to be output to the second individual ECU 2B includes setting information related to the second individual ECU 2B. In other words, the arithmetic processing device 100 of the integrated ECU 1 outputs the change instruction including the setting information according to the output destination to each of the individual ECUs 2. Note that the arithmetic processing device 100 of the integrated ECU 1 may output the setting information as a change instruction to each of the individual ECUs 2.

The arithmetic processing device 200 of the individual ECU 2 acquires (receives) the change instruction output from the integrated ECU 1. The arithmetic processing device 200 of the individual ECU 2 retrieves from the acquired change instruction the setting information related to the individual ECU 2 included in the change instruction. In other words, the arithmetic processing device 200 of the individual ECU 2 converts the acquired change instruction into a state available for the network setting in the individual ECU 2. Hereafter, the processing of acquiring a change instruction output from the arithmetic processing device 200 of the individual ECU 2 and taking setting information from the acquired change instruction is also referred to as reception processing. The arithmetic processing device 200 of the individual ECU 2 may perform pooling in the reception processing.

Hereafter, the time period from the time point when the arithmetic processing device 100 of the integrated ECU 1 outputs a change instruction to each individual ECU 2 to the time point when the arithmetic processing device 200 of each individual ECU 2 completes the reception processing in response to the change instruction output from the integrated ECU 1 is also referred to as a reception time period. In FIG. 8 described below, the reception time period for the first individual ECU 2A is denoted by Y1 while the reception time period for the second individual ECU 2B is denoted by Z1.

The arithmetic processing device 200 of the individual ECU 2 outputs the retrieved setting information to the relay processing unit 201 of the individual ECU 2 to change the network setting in the individual ECU 2 based on the retrieved setting information. Specifically, by outputting the retrieved setting information to the relay processing unit 201 of the individual ECU 2, the arithmetic processing device 200 of the individual ECU 2 outputs the changed parameters for the network setting of the in-vehicle network 4 to the relay processing unit 201 of the individual ECU 2 to cause the relay processing unit 201 of the individual ECU 2 to change the parameters. In other words, the relay processing unit 201 of the individual ECU 2 applies the setting information included in the change instruction to the relay processing unit 201 of the individual ECU 2.

Hereafter, the time period from the time point when the arithmetic processing device 200 of the individual ECU 2 starts outputting the setting information to the relay processing unit 201 of the individual ECU 2 to the time point when the relay processing unit 201 of the individual ECU 2 completes the changes of all the parameters that need to be changed in the individual ECU 2 is also referred to as a change time period. Note that the time point when the arithmetic processing device 200 of the individual ECU 2 starts outputting the setting information to the relay processing unit 201 of the individual ECU 2 corresponds to the time point when change of the network settings based on the change instruction is started in the individual ECU 2. The time point when the relay processing unit 201 of the individual ECU 2 completes changes of all the parameters that need to be changed in the individual ECU 2 corresponds to the time point when the change in the network settings based on the change instruction is completed in the individual ECU 2. In FIG. 8 to be described later, the change time period for the first individual ECU 2A is denoted by Y2 while the change time period for the second individual ECU 2B is denoted by Z2.

The above-mentioned reception time period and change time period are included in the second required time period. More specifically, the second required time period is the sum of the reception time period and the change time period. The larger the number of parameters to be changed is, the longer the time to change the parameters is, thereby increasing the change time period. Here, the second required time period thus increases. The smaller the number of parameters to be changed is, the shorter the time to change the parameters is, thereby reducing the change time period. Here, the second required time period thus decreases. For example, in outputting the setting information to the relay processing unit 201 of the individual ECU 2, the arithmetic processing device 200 of the individual ECU 2 communicates with the relay processing unit 201 multiple times. The larger the number of parameters to be changed is, the larger the number of communications described above is. The smaller the number of parameters to be changed is, the smaller the number of communications described above is.

When the network setting in the individual ECU 2 is completed, the relay processing unit 201 of the individual ECU 2 outputs a completion report indicating the completion of the network setting to the integrated ECU 1.

The method of deriving the first required time period and the second required time period performed by the arithmetic processing device 100 of the integrated ECU 1 is described below. The method of deriving the first required time period and the change time period included in the second required time period are first described.

As described above, increase in the number of parameters to be changed in both of the integrated ECU 1 and the individual ECU 2 requires more time for the first required time period and the change time period. In other words, the larger the amount of data of the setting information is, the longer the first required time period and the change time period are. That is, the first required time period and the change time period vary depending on the number of parameters to be changed or the amount of data in the setting information.

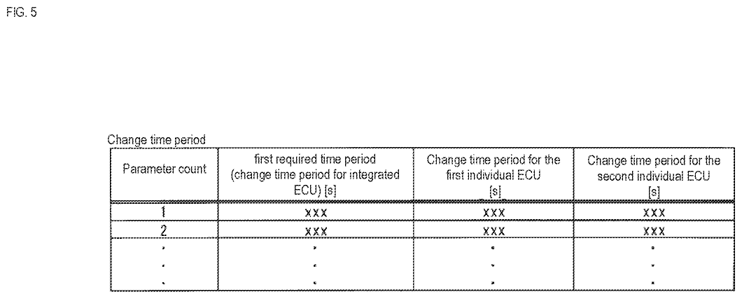

For example, the storage unit 11 of the integrated ECU 1 stores in advance a change time period table in which the number of parameters to be changed, the first required time period and the change time period are associated with one another. FIG. 5 is a schematic diagram exemplifying the contents of the change time period table. More specifically, the change time period table contains a parameter count column, a first required time period column, a change time period column for the first individual ECU 2A and a change time period column for the second individual ECU 2B.

The parameter count column stores the number of parameters to be changed in the integrated ECU 1 or the individual ECUs 2. The first required time period column stores the first required time period. The change time period column for the first individual ECU 2A stores the change time period for the first individual ECU 2A. The change time period column for the second individual ECU 2B stores the change time period for the second individual ECU 2B. The number of parameters to be changed is associated with the first required time period, the change time period for the first individual ECU 2A and the change time period for the second individual ECU 2B. For example, even if the number of parameters to be changed is the same, the change time period may be different among the first required time period, the first individual ECU 2A and the second individual ECU 2B due to the variations in the characteristics of the integrated ECU 1 and each individual ECU 2.

When deriving a first required time period, the arithmetic processing device 100 of the integrated ECU 1 specifies the number of parameters to be changed in the integrated ECU 1 based on the setting information and derives a first required time period based on the specified number of parameters with reference to the change time period table. When deriving a change time period of the individual ECU 2, the arithmetic processing device 100 of the integrated ECU 1 specifies the number of parameters to be changed in each individual ECU 2 based on the setting information and derives a change time period for each individual ECU based on the specified number of parameters with reference to the change time period table.

The change time period table is not limited to the above-mentioned example, but may be configured to store, for example, the amount of data of the setting information for the integrated ECU 1 and the amount of data of the setting information for each individual ECU 2 in association with the first required time period and the change time period, respectively. Note that the change time period table may be stored in the storage area accessible to the arithmetic processing device 100 of the integrated ECU 1 other than the storage unit 11 of the integrated ECU 1.

The average value of the time periods required to change one parameter may be stored in the storage unit 11 of the integrated ECU 1 or a storage area other than the storage unit 11, for example. The arithmetic processing device 100 of the integrated ECU 1 derives a first required time period by calculating the product of the number of parameters to be changed in the integrated ECU 1 and the average value of the time periods required to change one parameter. In addition, the arithmetic processing device 100 of the integrated ECU 1 derives a second required time period for each individual ECU 2 by calculating the product of the number of parameters to be changed in each individual ECU 2 and the average value of the time periods required to change one parameter.

It should be noted that the average value of the time periods required to change one parameter in the integrated ECU 1 may be different from the average value of the time periods required to change one parameter in each individual ECU 2. That is, the average value of the times required to change one parameter may be different for each ECU.

Next, the method of deriving a reception time period included in the second required time period is described. A reception time period preset based on a specification of each individual ECU 2, so called a design value (specification value defined in design) of the reception time period is stored in advance for each individual ECU 2 in the storage unit 11 of the integrated ECU 1. The design value of the reception time period for each individual ECU 2 may be stored in tabular form (reception time period table) in the storage unit 11 of the integrated ECU 1, as in the above-mentioned change time period table. The reception time table, which is stored in tabular form, stores the number of parameters to be changed and the reception time period for each individual ECU 2 in association with each other. The reception time period table and the change time period table are configured so that their setting values stored therein can be changed, updated, added and deleted. The arithmetic processing device 100 of the integrated ECU 1 reads from the storage unit 11 the design value of the reception time period corresponding to the individual ECU 2 as a transmission destination of the change instruction to derive the reception time period included in the second required time period for each individual ECU 2. For example, the design values of multiple reception time periods for each of the number of parameters to be changed or each range of the data amount of the change instruction to be output may be stored. The arithmetic processing device 100 of the integrated ECU 1 reads, out of the stored multiple reception time periods, the number of parameters to be changed in each individual ECU 2 or the design value of the reception time period corresponding to the amount of data of the change instruction to be output to each individual ECU 2 to thereby derive a reception time period. The design value of the second required time period may have been stored in a storage area other than the storage unit 11 of the integrated ECU 1.

For example, the arithmetic processing device 100 of the integrated ECU 1 may acquire the communication traffic of the communication between the integrated ECU 1 and the first individual ECU 2A or the second individual ECU 2B, and derive a reception time period of the first individual ECU 2A or the second individual ECU 2B based on the acquired communication traffic.

The arithmetic processing device 100 of the integrated ECU 1 calculates the sum of the derived reception time period and the change time period for each individual ECU 2 to derive the second required time period for each individual ECU 2.

Note that the first required time period may be regarded as the sum of the reception time period of the integrated ECU 1 and the change time period of the integrated ECU 1. Since the change of the network setting in the integrated ECU 1 does not require the output of a change instruction and the reception processing, the reception time period for the integrated ECU 1 is 0s. Here, the first required time period is the same as the change time period for the integrated ECU 1. The first required time period and the second required time period are collectively referred to as required time periods below.

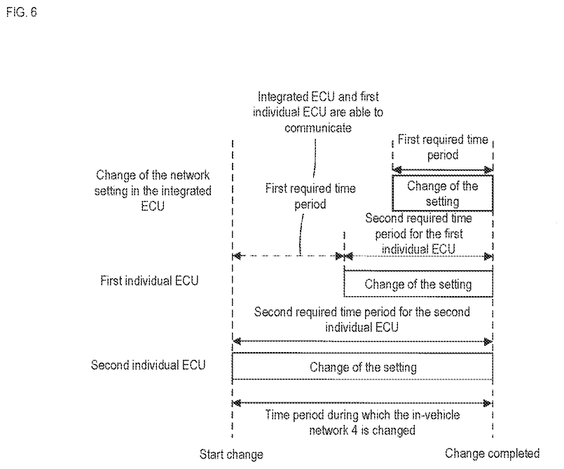

The following describes changes of the network settings performed on the integrated ECU 1 and the individual ECUs 2 in the order and at the time points according to the first required time period and the second required time periods by the arithmetic processing device 100 of the integrated ECU 1. FIG. 6 is an explanatory view exemplifying setting changes to the integrated ECU 1 and the individual ECUs 2 performed by the arithmetic processing device 100 of the integrated ECU 1.

The arithmetic processing device 100 of the integrated ECU 1 derives three required time periods including the first required time period, the second required time period for the first individual ECU 2A and the second required time period for the second individual ECU 2B as in the manner described above. In the example in FIG. 6, of the three required time periods, the second required time period for the second individual ECU 2B is the longest while the first required time period is the shortest.

FIG. 6 illustrates an example of changes of the settings performed on the integrated ECU 1 and the individual ECUs 2 in the order and at the time points according to the three required time periods by the arithmetic processing device 100 of the integrated ECU 1. The arithmetic processing device 100 of the integrated ECU 1 first generates setting information during the change of the settings. The arithmetic processing device 100 of the integrated ECU 1 outputs a change instruction to the second individual ECU 2B directly after the generation of the setting information during the change of the settings. The change of network setting in the second individual ECU 2B is started. In other words, the arithmetic processing device 100 of the integrated ECU 1 starts changing the network setting that requires the longest time period first after the generation of the setting information during the change of the settings.

The arithmetic processing device 100 of the integrated ECU 1 outputs a change instruction to the first individual ECU 2A after outputting the change instruction to the second individual ECU 2B. Specifically, the arithmetic processing device 100 of the integrated ECU 1 outputs a change instruction to the first individual ECU 2A so that the time point when the change of the network setting in the second individual ECU 2B is completed coincides with the time point when the change of the network setting in the first individual ECU 2A is completed. For example, the arithmetic processing device 100 of the integrated ECU 1 outputs a change instruction to the first individual ECU 2A when the time corresponding to the difference between the second required time period for the first individual ECU 2A and the second required time period for the second individual ECU 2B has elapsed from the time point when the change instruction is output to the second individual ECU 2B. The change of the network setting in the first individual ECU 2A is started. In other words, changing the network setting for the next longest required time period to the longest required time period is started second after the generation of the setting information during the change of the settings.

The arithmetic processing device 100 of the integrated ECU 1 starts changing the network setting in the integrated ECU 1 after outputting the change instruction to the first individual ECU 2A. Specifically, the arithmetic processing device 100 of the integrated ECU 1 starts changing the network setting in the integrated ECU 1 so that the time point when the changes of the network settings in the two individual ECUs 2 are completed and the time point when the change of the network setting in the integrated ECU 1 is completed coincide with each other. For example, the arithmetic processing device 100 of the integrated ECU 1 starts outputting setting information to the relay processing unit 101 of the integrated ECU 1 when the time period corresponding to the difference between the first required time period and the second required time period for the first individual ECU 2A has elapsed from the time point when the change instruction is output to the first individual ECU 2A. The change in the network setting that requires the shortest time period starts last.

The arithmetic processing device 100 of the integrated ECU 1 changes the settings as described above, which makes the time point when the change in the network setting in the integrated ECU 1 is completed coincides with the time points when the changes of the network setting in the two individual ECUs 2 are completed. While out of the three required time periods, the required time period that requires the longest time period elapses, the other two of the required time periods elapse. In addition, the period during which the network setting in the integrated ECU 1 is changed overlaps with the period during which the network settings in the two individual ECU 2 are changed. Note that the time point when a change in the network setting in the integrated ECU 1 is completed and the time points when changes of the network settings in the two individual ECUs 2 are completed do not necessarily strictly coincide with one another, and they may approximately coincide with one another, including a specification error of about a few seconds, for example.

Hereafter, the period during which at least one of the changes of the network settings in the integrated ECU 1, in the first individual ECU 2A and in the second individual ECU 2B is also referred to as the time period during which the in-vehicle network 4 is changed. Since the time point when a change of the network setting in the integrated ECU 1 is completed coincides with the time point when changes of the network setting in the two individual ECUs 2 are completed, the time period during which the in-vehicle network 4 is changed is the same as the second required time period for the second individual ECU 2B. In other words, the time period during which the in-vehicle network 4 is changed is the same as the required time period that requires the longest time period out of the derived required time periods.

In the time period during which the in-vehicle network 4 is being changed, the on-vehicle system S does not allow communication via the in-vehicle network 4. Note that the integrated ECU 1 and the first individual ECU 2A can communicate with each other during the period from the time point when the change in the network setting in the second individual ECU 2B is started until the time point when the change in the network setting in the first individual ECU 2A is started. If the time points when the network settings in the multiple ECUs are completed coincide one another, during the time period in which one of the ECUs is changing the network setting, the time period in which communication is allowed between the other ECUs before change in the network setting may be extended. In the example in FIG. 6, in the time period during which the in vehicle network 4 is changed, communication between the integrated ECU 1 and the first individual ECU 2A can be maintained for a long time period. In other words, the integrated ECU 1 can maintain the communication with the individual ECU 2 other than the individual ECU 2 that is changing the setting (the second individual ECU 2B in the present embodiment) for a long time.

When the changes of the network settings in the integrated ECU 1 and in the individual ECUs 2 are completed, communication is started via the changed in-vehicle network 4 in the on-vehicle system S. For example, when the network settings in the integrated ECU 1 and the individual ECUs 2 are completed, the relay processing unit 101 of the integrated ECU 1 and the relay processing unit 201 of each individual ECU 2 start relay processing based on the changed parameters. In other words, when the network settings in the integrated ECU 1 and each individual ECU 2 are completed, the relay processing unit 101 of the integrated ECU 1 starts the relay processing based on the setting information output from the arithmetic processing device 100 of the integrated ECU 1. In addition, the relay processing unit 201 of the individual ECU 2 starts the relay processing based on the setting information output from the arithmetic processing device 200 of the individual ECU 2.

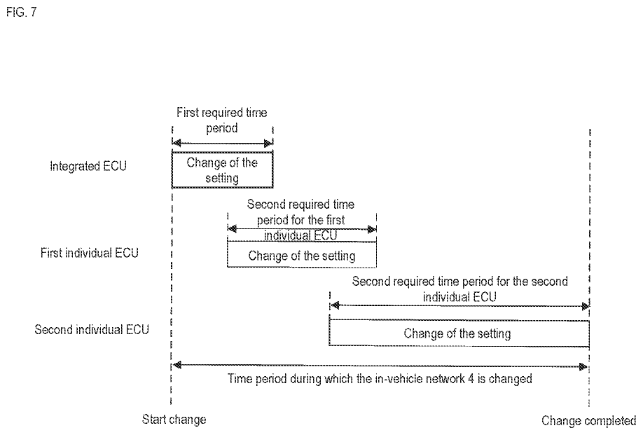

FIG. 7 is an explanatory view exemplifying changes of the settings, not taking the required time period into account. In the example in FIG. 7, of the three required time periods, the second required time period for the second individual ECU 2B is the longest while the first required time period is the shortest, as in the example in FIG. 6. The arithmetic processing device 100 of the integrated ECU 1 in the example in FIG. 7 starts changing the network setting in the integrated ECU 1 first after the generation of the setting information during the changes of the settings.

The arithmetic processing device 100 of the integrated ECU 1 outputs a change instruction to the first individual ECU 2A after starting the change of the network setting in the integrated ECU 1 without taking the required time period into account. The change in the network setting in the first individual ECU 2A is started. The arithmetic processing device 100 of the integrated ECU 1 outputs a change instruction to the second individual ECU 2B after outputting the change instruction to the first individual ECU 2A and completing the change of the network setting in the integrated ECU 1, without taking the required time period into account. The change in the network setting in the second individual ECU 2B is started.

Since in the example in FIG. 7, the period during which the network setting in the integrated ECU 1 is changed does not overlap with the period during which the network settings in the two individual ECUs 2 are changed, the time period during which the in-vehicle network 4 is changed is longer than that in the example in FIG. 6. Accordingly, the integrated ECU 1 and the individual ECU 2 in the example in FIG. 6 starts communication via the changed in vehicle network more quickly than those in FIG. 7 during the period when the setting of the in-vehicle network 4 is changed.

FIG. 8 is a sequence diagram illustrating one aspect of setting changes in the in-vehicle network 4. FIG. 8 describes the processing related to setting changes in the in-vehicle network 4 using a sequence diagram including the arithmetic processing device 100 and the relay processing unit 101 of the integrated ECU 1 and the arithmetic processing device 200 and the relay processing unit 201 of the first individual ECU 2A and the second individual ECU 2B. Hereafter, the step is abbreviated as S. For example, when the IG switch (not illustrated) provided on the vehicle C makes a transition from a stopped state to a start state, the integrated ECU 1, the first individual ECU 2A and the second individual ECU 2B are activated.

When an event that requires to change the settings of the in-vehicle network 4, for example, when connection of an additional on-vehicle component 3 to the individual ECU 2 occurs, the arithmetic processing device 100 of the integrated ECU 1 acquires a network (NW/Network) setting change request output from the individual ECU 2 or the on-vehicle component 3 connected to the individual ECU 2 (S11). The NW setting change request is information or a signal for requesting setting changes in the in-vehicle network 4. The arithmetic processing device 100 of the integrated ECU 1 may acquire a NW change request from the external server. For example, in the case where the setting information of the network to be updated is stored in the external server, the NW change request is transmitted from the external server to the integrated ECU 1 (vehicle C). When acquiring the NW setting change request, the arithmetic processing device 100 of the integrated ECU 1 generates the changed setting information of the in-vehicle network 4 in such a manner as described above.

The arithmetic processing device 100 of the integrated ECU 1 derives a first required time period and second required time periods for the first individual ECU 2A and the second individual ECU 2B in such a manner as described above (S12). The arithmetic processing device 100 of the integrated ECU 1 adjusts the timing when a first instruction related to a setting change is started (S13). For example, the arithmetic processing device 100 of the integrated ECU 1 specifies the order in which and the timing at which the network setting is to be changed in each ECU based on the required time period including the derived first required time period and second required time periods.

In the present embodiment, the arithmetic processing device 100 of the integrated ECU 1 starts changing the network settings in the ECUs in order from the ECU that requires the longer time period. Specifically, the arithmetic processing device 100 of the integrated ECU 1 changes the network settings in the ECUs so that the time points when changes of the network settings in the multiple ECUs are completed coincide with one another. The arithmetic processing device 100 of the integrated ECU 1 outputs a change instruction including the setting information related to the second individual ECU 2B to the second individual ECU 2B (S14).

The arithmetic processing device 200 of the second individual ECU 2B acquires a change instruction output from the integrated ECU 1 and retrieves the setting information related to the second individual ECU 2B from the acquired change instruction. That is, the arithmetic processing device 200 of the second individual ECU 2B performs reception processing in response to the change instruction output from the integrated ECU 1. The arithmetic processing device 200 of the second individual ECU 2B outputs the retrieved setting information to the relay processing unit 201 of the second individual ECU 2B (S15) to cause the relay processing unit 201 to change the parameters for the network setting. In FIG. 8, the second required time period for the second individual ECU 2B is Z1+Z2.

The arithmetic processing device 100 of the integrated ECU 1 adjusts the timing when a next instruction related to a setting change is started (S16). For example, the arithmetic processing device 100 of the integrated ECU 1 waits until the time corresponding to the difference between the second required time period for the first individual ECU 2A and the second required time period for the second individual ECU 2B has elapsed from the time point when the change instruction was output to the second individual ECU 2B. When the time corresponding to the difference has elapsed, the arithmetic processing device 100 of the integrated ECU 1 outputs a change instruction including the setting information related to the first individual ECU 2A to the first individual ECU 2A (S17).

The arithmetic processing device 200 of the first individual ECU 2A acquires the change instruction output from the integrated ECU 1 and retrieves the setting information related to the first individual ECU 2A from the acquired change instruction. The arithmetic processing device 200 of the first individual ECU 2A outputs the retrieved setting information to the relay processing unit 201 of the first individual ECU 2A (S18) to cause the relay processing unit 201 to change the parameters for the network setting. In FIG. 8, the second required time period for the first individual ECU 2A is Y1+Y2.

The arithmetic processing device 100 of the integrated ECU 1 adjusts the timing when a next instruction related to a setting change is started (S19). For example, the arithmetic processing device 100 of the integrated ECU 1 waits until the time corresponding to the difference between the first required time period and the second required time period for the first individual ECU 2A has elapsed from when the change instruction was output to the first individual ECU 2A. When the time corresponding to the difference has elapsed, the arithmetic processing device 100 of the integrated ECU 1 outputs the setting information related to the integrated ECU 1 to the relay processing unit 101 of the integrated ECU 1 (S20) to cause the relay processing unit 101 to change the parameters for the network setting. In FIG. 8, the first required time period is X2.

The changes of the network settings in each of the multiple ECUs including the integrated ECU 1 and the two individual ECUs are completed. As illustrated in FIG. 8, the time points when changes in the network settings are completed for the multiple ECUs coincide with one another. The settings of the in-vehicle network 4 are changed. When the change of the network setting in the second individual ECU 2B is completed, the second individual ECU 2B outputs a completion report indicating the completion of the change of the network setting in this individual ECU 2 to the integrated ECU 1 (S21). When the change of the network setting in the first individual ECU 2A is completed, the first individual ECU 2A outputs a completion report to the integrated ECU 1 (S22). The integrated ECU 1 and the two individual ECUs communicate with one another via the changed in-vehicle network 4. For example, the relay processing unit 101 of the integrated ECU 1 and the relay processing units 201 of the two individual ECUs perform relay processing based on the output setting information. For example, the arithmetic processing device 100 of the integrated ECU 1 may report that the change of the in-vehicle network 4 is completed to each of the individual ECUs 2 when the changes of the network setting in the multiple ECUs are completed.

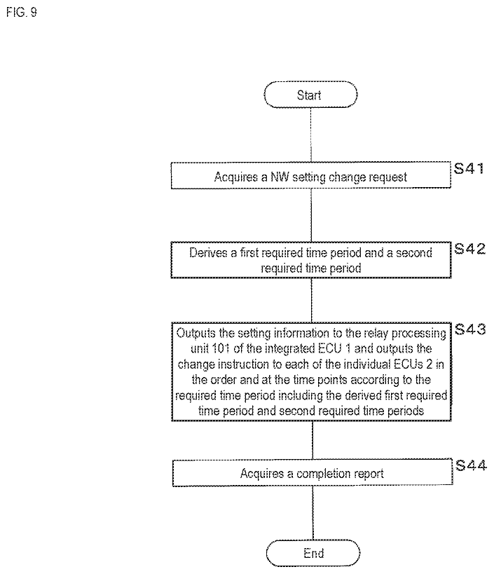

FIG. 9 is a flowchart exemplifying the processing related to changes in the settings of the in vehicle network 4 to be performed by the arithmetic processing device 100 of the integrated ECU 1. When the IG switch provided on the vehicle Cis shifted from a stop state to a start state, for example, the arithmetic processing device 100 of the integrated ECU 1 performs the following processing.

The arithmetic processing device 100 (control unit 10) of the integrated ECU 1 acquires a NW setting change request as described above (S41). Furthermore, the arithmetic processing device 100 of the integrated ECU 1 generates the changed setting information of the in-vehicle network 4 as described above. The arithmetic processing device 100 of the integrated ECU 1 derives a first required time period and a second required time period as described above (S42).

As described above, the arithmetic processing device 100 of the integrated ECU 1 outputs the setting information to the relay processing unit 101 of the integrated ECU 1 and outputs the change instruction to each of the individual ECUs 2 in the order and at the time points according to the required time period including the derived first required time period and second required time periods (S43). More specifically, the arithmetic processing device 100 of the integrated ECU 1 performs the following processing so that the time point when a change of the network setting in the integrated ECU 1 is completed and the time point when changes of the network setting in the individual ECUs 2 are completed coincide with one another. The arithmetic processing device 100 of the integrated ECU 1 outputs change instructions to the first individual ECU 2A and the second individual ECU 2B. In addition, the arithmetic processing device 100 of the integrated ECU 1 outputs the setting information to the relay processing unit 101 of the integrated ECU 1 to cause the relay processing unit 101 of the integrated ECU 1 to change the parameters for the network setting based on the output setting information. That is, the arithmetic processing device 100 of the integrated ECU 1 applies the setting information to the relay processing unit 101 of the integrated ECU 1 to change of the network setting in the integrated ECU 1.

The arithmetic processing device 100 of the integrated ECU 1 acquires a completion report output from each of the individual ECUs 2 (S44). The arithmetic processing device 100 of the integrated ECU 1 causes the relay processing unit 101 of the integrated ECU 1 to start relay processing based on the setting information output to the relay processing unit 101 of the integrated ECU 1. The arithmetic processing device 100 of the integrated ECU 1 may output to each of the individual ECUs 2 information or signals indicating that changes in the setting of the in-vehicle network 4 are completed. The arithmetic processing device 100 of the integrated ECU 1 ends the processing.

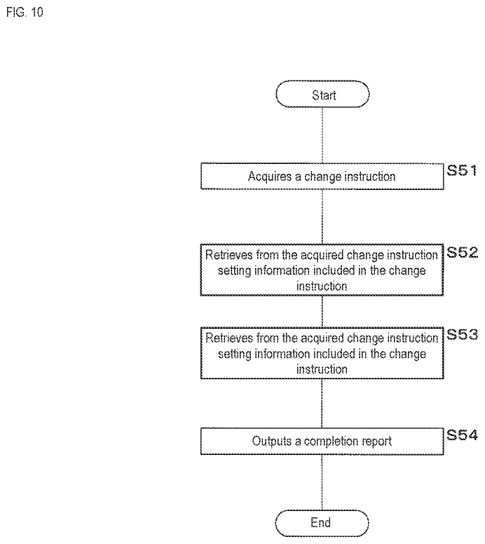

FIG. 10 is a flowchart exemplifying changes in the settings of the in-vehicle network 4 performed by the arithmetic processing device 200 of the individual ECU 2. When the IG switch provided on the vehicle C is shifted from a stopped state to a start state, for example, the arithmetic processing device 200 of the individual ECU 2 performs the following processing.

The arithmetic processing device 200 (control unit 20) of the individual ECU 2 acquires a change instruction output from the integrated ECU 1 (S51) and retrieves from the acquired change instruction setting information included in the change instruction (S52). In other words, the arithmetic processing device 200 of the individual ECU 2 performs reception processing in response to the change instruction output from the integrated ECU 1. The arithmetic processing device 200 of the individual ECU 2 outputs the retrieved setting information to the relay processing unit 201 of the individual ECU 2 (S53) and causes the relay processing unit 201 of the individual ECU 2 to change the parameters for the network setting based on the output setting information. In other words, the arithmetic processing device 200 of the individual ECU 2 applies the retrieved setting information to the relay processing unit 201 of the individual ECU 2.

When the change in the network setting in the individual ECU 2 is completed, that is, when changes of the parameters for the network setting in the relay processing unit 201 of the individual ECU 2 are completed, the arithmetic processing device 200 of the individual ECU 2 outputs a completion report to the integrated ECU 1 (S54).

The arithmetic processing device 200 of the individual ECU 2 causes the relay processing unit 201 of the individual ECU 2 to start relay processing based on the setting information output to the relay processing unit 201 of the individual ECU 2. For example, the arithmetic processing device 200 of the individual ECU 2 causes the relay processing unit 201 of the individual ECU 2 to start the relay processing when a predetermined time period has elapsed from the time point when the change of the network setting in the individual ECU 2 was completed. For example, the predetermined time period has been stored in the storage unit 21 of the individual ECU 2 in advance. When acquiring information or a signal indicating the completion of changing the settings in the in-vehicle network 4 output from the integrated ECU 1, the arithmetic processing device 200 of the individual ECU 2 may cause the relay processing unit 201 of the individual ECU 2 to start the relay processing. The arithmetic processing device 200 of the individual ECU 2 ends the processing.

In the present embodiment, the integrated ECU 1 is connected to the multiple individual ECUs 2 that act as relay devices. In changing the setting of the in-vehicle network 4, the control unit 10 of the integrated ECU 1 derives a first required time period and a second required time period. The control unit 10 of the integrated ECU 1 further changes the settings in the integrated ECU 1 and the individual ECUs 2 in the order and at the time points corresponding to the first required time period and the second required time periods so that a first period during which the network setting in the integrated ECU 1 is changed overlaps with a second period during which the network settings in the multiple individual ECUs 2 are changed. Specifically, the control unit 10 of the integrated ECU 1 generates the setting information of the in-vehicle network 4 in response to the occurrence of the event that requires to change the settings of the in-vehicle network 4. After completion of generating the setting information, the control unit 10 of the integrated ECU 1 changes the network setting in the integrated ECU 1 using the setting information and outputs a change instruction generated using the setting information to the individual ECUs 2 in the order according to the first required time period and the second required time period so that the first period and the second periods overlap one another. The individual ECUs 2 each acquires the change instruction output from the integrated ECU 1 and changes the network setting in the individual ECU 2 based on the acquired change instruction. By overlapping the first period and the second periods, the control unit 10 of the integrated ECU 1 can reduce the differences between the time point when the change in the network setting in the integrated ECU 1 is completed and the time points when the changes of the settings in the individual ECUs 2 are completed.

After completion of changing the network setting in the integrated ECU 1 and changing the network settings in the individual ECUs 2, communication via the changed in-vehicle network 4 is carried out. In changing the settings of the in-vehicle network 4, the first period and each of the second periods overlap with one another, so that the integrated ECU 1 can reduce the time period required to change the settings of the in-vehicle network 4 as compared to when the first period and each of the second periods do not overlap with one another. Accordingly, in the on-vehicle system S, the integrated ECU 1 can quickly start communication via the changed in-vehicle network 4 during changes of the settings in the in-vehicle network 4.

The control unit 10 of the integrated ECU 1 includes the arithmetic processing device 100 that derives a first required time period and a second required time period and the relay processing unit 101 that performs relay processing. The arithmetic processing device 100 of the integrated ECU 1 outputs the setting information to the relay processing unit 101 of the integrated ECU 1 and outputs a change instruction to the individual ECUs 2 in the order and at the time points according to the derived first required time period and second required time period. The relay processing unit 101 of the integrated ECU 1 performs relay processing based on the output setting information. The on-vehicle ECU can efficiently relay the communication.

The relay processing unit 101 of the integrated ECU 1 functions as a layer 2 switch or a layer 3 switch, which allows the relay processing unit 101 of the integrated ECU 1 to efficiently perform the relay processing of communication depending on each layer.

In the present embodiment, the arithmetic processing device 100 (control unit 10) of the integrated ECU 1 changes the settings so that the first time point when the change of the network setting in the integrated ECU 1 is completed coincides with the second time point when changes of the network settings in the multiple individual ECUs 2 are completed. Since the time points when the changes of the network setting are completed coincide among the integrated ECU 1 and each of the individuals ECUs 2, the change of the settings of the in-vehicle network 4 is completed at the time point when the change of the network setting that requires the longest time is completed, out of the required time period including the derived first required time period and second required time period. The integrated ECU 1 can efficiently change the network settings in the integrated ECU 1 and each of the individual ECUs 2. Furthermore, the integrated ECU 1 can reduce the time required to change the settings of the in-vehicle network 4. Accordingly, in changing the settings of the in-vehicle network 4, the integrated ECU 1 can start communication via the changed in-vehicle network 4 more quickly.

When the network setting is being changed in one of the two individual ECUs 2 connected to the integrated ECU 1, the integrated ECU 1 and the other one of the individual ECUs 2 can communicate with each other until change of the network setting is started in the integrated ECU 1 or the other one of the individual ECUs 2. The change of the settings are performed so that the first time point, the second time point for one of the individual ECUs 2 and the second time point for the other one of the individual ECUs 2 coincide with one another. While the network setting is being changed in one of the individual ECUs 2, the integrated ECU 1 can thus extend the period during which the integrated ECU 1 and the other one of the individual ECUs 2 can communicate before change of the network setting is started.

The second required time period is a sum of a reception time period and a change time period. The reception time period is the time period from the time point when the integrated ECU 1 outputs a change instruction to the individual ECU 2 to the time point when the individual ECU 2 completes reception processing in response to the change instruction. During the reception time period, communication for change of the network setting in the individual ECU 2 is performed between the integrated ECU 1 and the individual ECU 2. The change time is the time period from the time point when the change in the network setting based on the change instruction is started in the individual ECU 2 to the time point when the change in the network setting based on the change instruction is completed. Taking into account the time period required for the communication for change of the network setting in the individual ECU 2 and the reception processing as a reception time period, the integrated ECU 1 can accurately derive the time required to change the network setting in the individual ECU 2. Since the integrated ECU 1 derives the time period from the time point when the change instruction is output to the individual ECU 2 to the time point when the change of the network setting in the individual ECU 2 is completed as the second required time period, it can change the settings in a more appropriate order and at a more appropriate time points.

In the present embodiment, though the on-vehicle system S is configured with the integrated ECU 1 and the individual ECUs 2, the configuration is not limited thereto. For example, the on-vehicle system S may be composed of multiple ECUs connected through peer-to-peer communication by a relay device such as an Ethernet switch that is provided separately from the ECUs. Any one of the ECUs out of the multiple ECUs changes the network setting in the ECU of itself as in the integrated ECU 1 described above and outputs change instructions to the relay device or the relay device and the other ones of the ECUs. In this case, the above-mentioned one of the ECUs corresponds to the on-vehicle ECU.

The integrated ECU 1 may directly be connected with the on-vehicle component 3. The integrated ECU 1 relays communication between the on-vehicle component 3 connected to the integrated ECU 1 and the on-vehicle component 3 connected to the individual ECU 2 via the individual ECU 2. If the integrated ECU 1 is directly connected with multiple on-vehicle components 3, for example, the integrated ECU 1 relays communication between the multiple on-vehicle components 3 connected to the integrated ECU 1.

### Second Embodiment

Of the parts corresponding to the second embodiment, same parts in the first embodiment will be denoted by the same reference codes and will not be described. The second embodiment relates to the integrated ECU 1 that changes the settings so that during the time in which the network setting for the required time that requires the longest time period out of the multiple required time periods is being changed, the network settings for the other ones of the required time periods are changed.

The vehicle C according to the second embodiment is equipped with an integrated ECU 1 and two individual ECUs 2 as in the first embodiment. The integrated ECU 1 includes an arithmetic processing device 100 and a relay processing unit 101. The individual ECUs 2 each include an arithmetic processing device 200 and a relay processing unit 201. The arithmetic processing device 100 of the integrated ECU 1 derives three required time periods including a first required time period and second required time periods for the two respective individual ECUs as in the first embodiment. The arithmetic processing device 100 of the integrated ECU 1 according to the second embodiment changes the settings so that while the network setting for the required time period that requires the longest time period of the derived required time periods is being changed, the changes of the network settings for the other ones of the required time periods are started and completed.

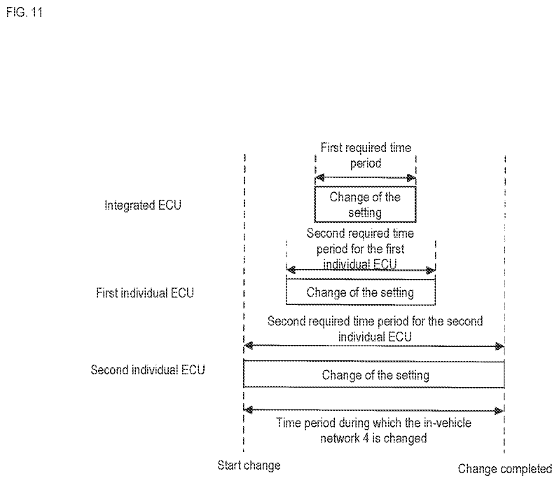

FIG. 11 is an illustrative view exemplifying changes of the setting in the integrated ECU 1 and the individual ECUs 2 to be performed by the arithmetic processing device 100 of the integrated ECU 1 according to the second embodiment. In the example illustrated in FIG. 11, of the three required time periods, the second required time period for the second individual ECU 2B is the longest while the first required time period is the shortest.

The arithmetic processing device 100 of the integrated ECU 1 outputs a change instruction to the second individual ECU 2B directly after the generation of the setting information during change of the settings. The change of network setting in the second individual ECU 2B is started. In other words, the network setting for the required time period that requires the longest time period of the three required time periods is started.

After outputting a change instruction to the second individual ECU 2B, the arithmetic processing device 100 of the integrated ECU 1 outputs a change instruction to the first individual ECU 2A based on the respective second required time periods for the two individual ECUs 2. Specifically, the processing unit 100 of the integrated ECU 1 outputs a change instruction to the first individual ECU 2A so that during the time in which the network setting in the second individual ECU 2B is being changed, the changes in the network setting in the first individual ECU 2A is started and completed. The change of the network setting in the first individual ECU 2A is started.

After outputting the change instruction to the first individual ECU 2A, the arithmetic processing device 100 of the integrated ECU 1 starts changing the network setting in the integrated ECU 1 based on the first required time period and the second required time period for the first individual ECU 2A. More specifically, the arithmetic processing device 100 of the integrated ECU 1 starts outputting the setting information to the relay processing unit 101 of the integrated ECU 1 so that the change of the network setting in the integrated ECU 1 is started and completed while the network setting in the first integrated ECU 2A is being changed.

The changes in the setting by the arithmetic processing device 100 of the integrated ECU 1 in the manner as described above allows the time periods during which changes of the network settings in the three ECUs including the integrated ECU 1 and the two individual ECUs are performed to overlap with one another. Specifically, during the period in which the network setting in the second individual ECU 2B out of the three ECUs is being changed, changes of the network settings in the other two of the ECUs are started and completed. Before the change of the network setting in the second individual ECU 2B is completed, the changes of the network settings in the other two of the ECUs are complete. The change of the settings in the in-vehicle network 4 is completed when the change of the network setting in the second individual ECU 2B is completed, and thus the time period during which the in-vehicle network 4 is changed is the same as the second required time period. The arithmetic processing device 100 of the integrated ECU 1 can efficiently change the network settings in the integrated ECU 1 and each of the individual ECUs 2.

The arithmetic processing device 100 of the integrated ECU 1 can reduce the time period during which the in-vehicle network 4 is changed in comparison with the case where the time periods when changes of the network setting in the respective ECUs do not overlap with one another. Thus, it is possible to quickly start the communication via the changed in-vehicle network 4.

As in the first embodiment, the on-vehicle system S does not allow communication via the in-vehicle network 4 in the period during which the in-vehicle network 4 is being changed. However, the integrated ECU 1 and the first individual ECU 2A can communicate with each other during the period from the time point when the change of the network setting in the second individual ECU 2B is started to the time point when the change of the network setting in the first individual ECU 2A is started.

In the case of the second embodiment, during the time period during which the in-vehicle network 4 is being changed, the period during which the integrated ECU 1 and the first individual ECU 2A can communicate before starting the change in the network setting is shorter than the period in the first embodiment. In other words, in the case of the first embodiment, in the time period during which the network setting of one of the multiple ECUs is being changed, the time period during which the other ones of the ECUs before starting the change of the network setting are able to communicate can be extended.

In the present embodiment, the network setting for the required time period that requires the longest time period of the multiple required time periods including the first required time period and the second required time period is being changed, the network settings for the other ones of the required time periods are changed. For example, the arithmetic processing device 100 of the integrated ECU 1 may change the settings so that the time points when changes of the network settings in the multiple ECUs including the integrated ECU 1 and the individual ECUs 2 are started coincide with one another.

The integrated ECU 1 performs a series of processing for the setting change such that the period during which the network setting in the integrated ECU 1 is changed overlaps with the period during which the network settings in each of the multiple individual ECUs 2 are changed. For example, the arithmetic processing device 100 of the integrated ECU 1 may change the setting such that a part of the period during which the network setting in the integrated ECU 1 is changed overlaps with parts of the periods during which the network settings in each of the multiple individual ECU 2 are changed.

For example, the setting may be changed such that a part of the period during which the network setting in the integrated ECU 1 is changed, a part of the period during which the network setting in the first individual ECU 2A is changed and a part of the period during which the network setting in the second individual ECU 2B is changed overlap with one another. In the case where the periods during which the three network settings are changed do not overlap with one another, the time period required to change the in-vehicle network 4 can be reduced in comparison with the case where in response to the completion of changing one of the three settings, another one of the settings is changed.

It is to be understood that the first and second embodiments disclosed here are illustrative in all respects and not restrictive. The scope of the present disclosure is defined by the appended claims, not by the above-mentioned meaning, and all changes that fall within the meanings and the bounds of the claims, or equivalence of such meanings and bounds are intended to be embraced by the claims.

1. An in-vehicle control device to be installed in a vehicle and comprising a control circuit performing control related to communication between a first in-vehicle device and a second in-vehicle device via an in-vehicle network,
wherein the control circuit executes
generates setting information of the in-vehicle network according to a state of the vehicle,
derives a required time period required to change a network setting according to the setting information in the first in-vehicle device,
derives a required time period required to change a network setting according to the setting information in the second in-vehicle device, and
performs a setting change instruction on at least one of the network setting in the first in-vehicle device and the network setting in the second in-vehicle device so that the derived two required time periods at least partially overlap with each other.

2. The in-vehicle control device according to claim 1, wherein the in-vehicle control device is included in at least one of the first in-vehicle device and the second in-vehicle device.

3. The in-vehicle control device according to claim 1, wherein
the control circuit includes a relay processing circuit that performs relay processing of communication between the first in-vehicle device and the second in-vehicle device,
the control circuit specifies an order of and a time point at which changes of the network settings are started by the first in-vehicle device and the second in-vehicle device based on the required time periods, outputs the setting information to the relay processing circuit and performs a setting change instruction on at least one of the network setting in the first in-vehicle device and the network setting in the second in-vehicle device, according to specified order and time point, and
the relay processing circuit starts changing the network setting according to the outputted setting information.

4. The in-vehicle control device according to claim 3, wherein the relay processing circuit functions as a layer 2 switch or a layer 3 switch.

5. The in-vehicle control device according to claim 1, wherein the control circuit
specifies a longest required time period for each of the required time periods, and
performs a setting change instruction on at least one of the network setting in the first in-vehicle device and the network setting in the second in-vehicle device so that in a time period during which one of the network settings that requires the specified longest required time period is being changed, the other one of the network settings is changed.

6. The in-vehicle control device according to claim 1, wherein the control circuit performs a setting change instruction on at least one of the network setting in the first in-vehicle device and the network setting in the second in-vehicle device so that a time point when a change of the network setting in the first in-vehicle device is completed coincides with a time point when a change of the network setting in the second in-vehicle device is completed.

7. The in-vehicle control device according to claim 1, wherein the required time period for the second in-vehicle device includes
a reception time period from a time point when the control circuit outputs the setting change instruction to the second in-vehicle device to a time point when the second in-vehicle device completes reception processing in response to the setting change instruction, and
a change time period from a time point when a change of the network setting is started to a time point when the change of the network setting is completed based on the setting change instruction for which the reception processing is completed in the second in-vehicle device.

8. The in-vehicle control device according to claim 1, wherein the control circuit generates, in a case where an event that shifts a state of the vehicle is detected, the setting information based on the event.

9. The in-vehicle control device according to as claim 1, wherein
the in-vehicle network is connected to a plurality of the second in-vehicle devices functioning as relay devices, and
the control circuit of the first in-vehicle device functioning as the in-vehicle control device controls communication with the relay devices.

10. An in-vehicle system installed in a vehicle and comprising a first in-vehicle device and a second in-vehicle device so connected as to be able to communicate with each other via an in-vehicle network, at least one of the first in-vehicle device and the second in-vehicle device functioning as an in-vehicle control device having a control circuit,
the control circuit
generates setting information of the in-vehicle network according to a state of the vehicle,
derives a required time period required to change a network setting according to the setting information in the first in-vehicle device,
derives a required time period required to change a network setting according to the setting information in the second in-vehicle device, and
performs a setting change instruction on at least one of the network setting in the first in-vehicle device and the network setting in the second in-vehicle device so that the derived required time periods at least partially overlap with each other.

11. An information processing method causing an in-vehicle control device installed in a vehicle and performing control related to communication between a first in-vehicle device and a second in-vehicle device via an in-vehicle network to execute processing of:
generating setting information of the in-vehicle network according to a state of the vehicle;
deriving a required time period required to change a network setting according to the setting information in the first in-vehicle device;
deriving a required time period required to change a network setting according to the setting information in the second in-vehicle device; and
performing a setting change instruction on at least one of the network setting in the first in-vehicle device and the network setting in the second in-vehicle device so that the derived required time periods at least partially overlap with each other.

12. A program causing an in-vehicle control device installed in a vehicle and performing control related to communication between a first in-vehicle device and a second in-vehicle device via an in-vehicle network to execute processing of:
generating setting information of the in-vehicle network according to a state of the vehicle;
deriving a required time period required to change a network setting according to the setting information in the first in-vehicle device;
deriving a required time period required to change a network setting according to the setting information in the second in-vehicle device; and
performing a setting change instruction on at least one of the network setting in the first in-vehicle device and the network setting in the second in-vehicle device so that the derived required time periods at least partially overlap with each other.

13. The in-vehicle control device according to claim 2, wherein
the control circuit includes a relay processing circuit that performs relay processing of communication between the first in-vehicle device and the second in-vehicle device,
the control circuit specifies an order of and a time point at which changes of the network settings are started by the first in-vehicle device and the second in-vehicle device based on the required time periods, outputs the setting information to the relay processing circuit and performs a setting change instruction on at least one of the network setting in the first in-vehicle device and the network setting in the second in-vehicle device, according to specified order and time point, and
the relay processing circuit starts changing the network setting according to the outputted setting information.

14. The in-vehicle control device according to claim 2, wherein the control circuit
specifies a longest required time period for each of the required time periods, and
performs a setting change instruction on at least one of the network setting in the first in-vehicle device and the network setting in the second in-vehicle device so that in a time period during which one of the network settings that requires the specified longest required time period is being changed, the other one of the network settings is changed.

15. The in-vehicle control device according to claim 3, wherein the control circuit
specifies a longest required time period for each of the required time periods, and
performs a setting change instruction on at least one of the network setting in the first in-vehicle device and the network setting in the second in-vehicle device so that in a time period during which one of the network settings that requires the specified longest required time period is being changed, the other one of the network settings is changed.

16. The in-vehicle control device according to claim 4, wherein the control circuit
specifies a longest required time period for each of the required time periods, and
performs a setting change instruction on at least one of the network setting in the first in-vehicle device and the network setting in the second in-vehicle device so that in a time period during which one of the network settings that requires the specified longest required time period is being changed, the other one of the network settings is changed.

17. The in-vehicle control device according to claim 2, wherein the control circuit performs a setting change instruction on at least one of the network setting in the first in-vehicle device and the network setting in the second in-vehicle device so that a time point when a change of the network setting in the first in-vehicle device is completed coincides with a time point when a change of the network setting in the second in-vehicle device is completed.

18. The in-vehicle control device according to claim 3, wherein the control circuit performs a setting change instruction on at least one of the network setting in the first in-vehicle device and the network setting in the second in-vehicle device so that a time point when a change of the network setting in the first in-vehicle device is completed coincides with a time point when a change of the network setting in the second in-vehicle device is completed.

19. The in-vehicle control device according to claim 4, wherein the control circuit performs a setting change instruction on at least one of the network setting in the first in-vehicle device and the network setting in the second in-vehicle device so that a time point when a change of the network setting in the first in-vehicle device is completed coincides with a time point when a change of the network setting in the second in-vehicle device is completed.

20. The in-vehicle control device according to claim 5, wherein the control circuit performs a setting change instruction on at least one of the network setting in the first in-vehicle device and the network setting in the second in-vehicle device so that a time point when a change of the network setting in the first in-vehicle device is completed coincides with a time point when a change of the network setting in the second in-vehicle device is completed.
